(19) United States
(12) Patent Application Publication
(10) Pub. No.: US 2024/0249182 A1
(43) Pub. Date: Jul. 25, 2024

(54) GENERATION AND DEPLOYMENT OF CONTEXT-SPECIFIC MACHINE LEARNING MODELS

(71) Applicant: Microsoft Technology Licensing, LLC, Redmond, WA (US)

(72) Inventors: Gilad KIRSHENBOIM, Petach Tiqva (IL); Segev RAVGAD, Ramat Hasharon (IL); Shital SHAH, Sammamish, WA (US); Debadeepta DEY, Kenmore, WA (US); Allison Paige DEL GIORNO, Kirkland, WA (US)

(73) Assignee: Microsoft Technology Licensing, LLC, Redmond, WA (US)

(21) Appl. No.: 18/101,279

(22) Filed: Jan. 25, 2023

(51) Int. Cl. G06N 20/00

(52) U.S. Cl. CPC G06N 20/00

(57) ABSTRACT

This document relates to automated generation and deployment of machine learning models, such as neural networks. One example method involves obtaining a base machine learning model adapted for a plurality of contexts. The method also includes deriving, from the base machine learning model, multiple context-specific machine learning models adapted for different contexts of the plurality of contexts. The method also includes outputting the multiple context-specific machine learning models for use in the different contexts.

### BACKGROUND

Machine learning models can be employed for a wide range of applications. In some cases, machine learning models can be very large, e.g., the GPT-3 model has approximately 175 billion parameters that use 800 gigabytes of storage. Large models such as BLOOM, GPT-3, ResNet-50, or NASNet Large tend to be more accurate than smaller models and can perform well in a wide range of contexts. However, the size of these models can present practical difficulties.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for automated generation of machine learning models. One example includes a method or technique that can be performed on a computing device. The method or technique can include obtaining a plurality of context-specific machine learning models. Each context-specific machine learning model can be derived from a base machine learning model adapted to a plurality of contexts and each context-specific model can be adapted to a different context of the plurality of contexts. The method or technique can also include detecting a particular context of a particular device. The method or technique can also include selecting a particular context-specific machine learning model from the plurality of context-specific machine learning models based at least on the particular context of the particular device, and providing the particular context-specific machine learning model to the particular device.

Another example includes a method or technique that can be performed on a computing device. The method or technique can include obtaining a base machine learning model adapted for a plurality of contexts. The method or technique can also include deriving, from the base machine learning model, multiple context-specific machine learning models adapted for different contexts of the plurality of contexts. The method or technique can also include outputting the multiple context-specific machine learning models for use in the different contexts.

Another example includes a computing device that includes a hardware processing unit and a storage resource. The storage resource stores computer-readable instructions which, when executed by the hardware processing unit, cause the hardware processing unit to receive a particular context-specific machine learning model adapted for a particular context. The particular context-specific machine learning model can be derived from a base machine learning model adapted for a plurality of contexts. The computer-readable instructions can also cause the hardware processing unit to execute the particular context-specific machine learning model on the computing device when the computing device is in the particular context.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example distillation scenario of knowledge from a base machine learning model to multiple context-specific machine learning models, consistent with some implementations of the present concepts.

FIG. 2 illustrates an example deployment scenario of a context-specific machine learning model to a client device, consistent with some implementations of the present concepts.

FIG. 3 illustrates an example teaching scenario for knowledge distillation from a base machine learning model to a context-specific machine learning model, consistent with some implementations of the present concepts.

FIG. 4 illustrates an example search procedure for finding an architecture of a context-specific machine learning model, consistent with some implementations of the present concepts.

FIGS. 5A, 5B, 5C, and 5D illustrate examples of modifications that can be performed to machine learning models during a search procedure, consistent with some implementations of the present concepts.

FIG. 6 illustrates an example model generation workflow for generating a machine learning model, consistent with some implementations of the present concepts.

FIGS. 7A, 7B, and 7C illustrate scatterplots associated with consecutive iterations of a machine learning model search procedure, consistent with some implementations of the present concepts.

FIG. 8 illustrates an example pruning scenario for knowledge distillation from a base machine learning model to a context-specific machine learning model, consistent with some implementations of the present concepts.

FIG. 9 illustrates an example system, consistent with some implementations of the present concepts.

FIG. 10 illustrates an example execution scenario for a compressed machine learning model, consistent with some implementations of the present concepts.

FIG. 11 illustrates an example graphical user interface, consistent with some implementations of the present concepts.

FIGS. 12, 13, and 14 are flowcharts of example methods or techniques, consistent with some implementations of the present concepts.

### DETAILED DESCRIPTION

### Overview

As noted above, large machine learning models tend to perform well in a variety of contexts. For instance, consider GitHub Copilot, which starts with a pretrained GPT-3 based model that has been tuned to generate code in multiple different programming languages, such as Python, JavaScript, Perl, etc. This model is very large and as a consequence generally runs on cloud resources, as the model is too large to run on most client devices. However, cloud resources tend to be fairly expensive and can have latency and/or availability issues, particularly during times of heavy use.

One approach for client-side execution of a machine learning model involves training a smaller model for a wide range of contexts. However, smaller models generally do not perform as well as larger models when trained directly on training data for a wide range of contexts. For instance, large models tend to learn conceptual abstractions that can help the model perform well in different contexts, but smaller models may not learn such conceptual abstractions directly from training data.

The disclosed implementations provide techniques for deriving context-specific machine learning models from a base machine learning model. The context-specific machine learning models can be small enough that they can be executed efficiently on a client device, which may have constrained resources compared to a cloud server. In some cases, a context prediction scheme is employed to automatically detect the context of a particular client device, and the client device can then load and execute a corresponding context-specific machine learning model for the detected context.

Various approaches are provided for deriving context-specific machine learning models from a base machine learning model. A first approach involves conducting a search for a suitable architecture, and then using the base machine learning model to teach different instances of the selected architecture using context-specific training data for different contexts. A second approach involves using knowledge distillation to prune certain parameters from the base machine learning model or another model derived from the base model using the first approach to obtain different context-specific machine learning models with fewer active parameters than the base machine learning model. Pruning can involve setting, to zero, individual parameters of the model that do not contribute significantly toward the performance of the model in a particular context.

To further facilitate execution on resource-constrained client devices, each context-specific machine learning model can be compressed into respective slices. Each slice can have a corresponding size suited to the hardware capabilities of the client device that will execute the model. For instance, each slice could include a parameter matrix for a specific layer of a machine learning model, where the parameters for that layer fit into the memory of an inference processing unit (e.g., a neural processing unit or “NPU”) of the client device.

### Machine Learning Background

There are various types of machine learning frameworks that can be trained to perform a given task, such as natural language understanding, natural language generation, detecting objects in images, generating images from text, etc. Support vector machines, decision trees, and neural networks are just a few examples of machine learning frameworks that have been used in a wide variety of applications. Some machine learning frameworks, such as neural networks, use layers of operations or “nodes” that are connected together by one or more edges.

In a neural network, nodes are connected to one another via one or more edges. A neural network can include an input layer, an output layer, and one or more intermediate layers. Individual nodes in each layer can perform specific operations on their inputs, such as convolution operations, vector operations, matrix operations, pooling operations, activation function operations, embedding operations, decoding or encoding operations, attention operations, etc. Each operation can provide an output to a subsequent layer, or, in some cases, a previous layer. The inputs to a given node can be multiplied by corresponding weight values for an edge between the input and the node. In addition, nodes can have individual bias values that are also used to produce outputs. Various training procedures can be applied to learn the edge weights and/or bias values.

Neural networks and other machine learning models can be viewed as operating in two phases—training and inference. In the training phase, the model is used to make predictions given training data and the model parameters are updated based on whether those predictions are correct. In the inference phase, the trained model is employed to process input data to perform a particular task, often without further modification to the model parameters. Training can involve algorithms such as batch gradient descent that perform calculations of an error gradient to update the model parameters. In contrast, inference generally does not involve such calculations. Because inference processing does not necessarily involve training calculations, it is possible to build special-purpose inference processing units, such as NPUs, that are particularly efficient at performing inference operations and does not necessarily need to fully support model training.

For instance, an inference processing unit might be implemented as a systolic array. In such an array, input data can be divided and distributed to a group of parallel nodes that each perform the same operation on a subset of the input data, and then pass the results of their processing to the next group of nodes in the array. For instance, individual hardware nodes can perform multiply and accumulate operations on specified data sizes very quickly, e.g., using dedicated circuitry to perform large convolution or matrix multiplication operations in relatively few processing cycles and using relatively few memory transfer operations. For instance, a large matrix or vector can be loaded into or output to memory in a single operation.

In contrast, implementing a large convolution or matrix multiplication on a conventional CPU tends to involve executing a long stream of sequential operations. Individual instructions can retrieve portions of matrices or vectors from memory and process them individually, and then subsequent operations can combine intermediate results into a final output. As a consequence, complex convolution or matrix operations tend to be far less efficient on general-purpose CPU's than when implemented on dedicated inference processing units. A CPU implementation of a large convolution or matrix operation can have far higher latency, power consumption, and/or memory utilization than the same operation implemented using hardware-supported inference operations.

However, inference processing units tend to have certain practical limitations. For instance, the SRAM capacity of an NPU might be on the order of 500 KB to several megabytes. As a consequence, it is often not practical to execute a full-context base machine learning model on an NPU, because the layers of the full-context base model may be too large to fit into the SRAM. In addition, the full-context base machine learning model may include operations that are not supported by the NPU.

### Model Distillation

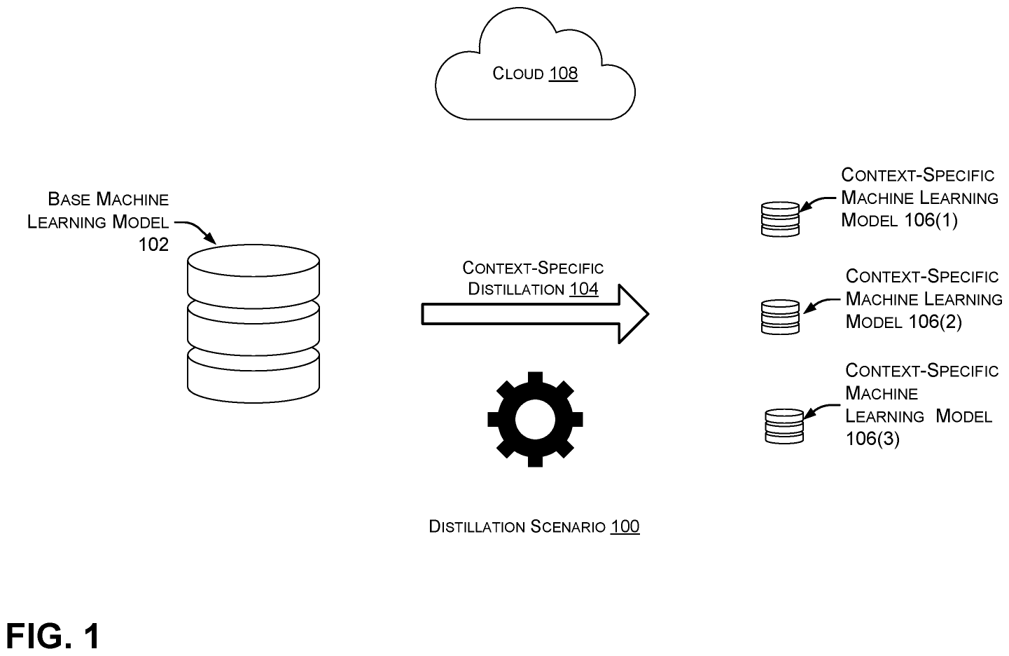

FIG. 1 illustrates a distillation scenario 100 for generating context-specific machine learning models. A base machine learning model 102 is processed using context-specific distillation 104 to obtain context-specific machine learning models 106(1), 106(2), and 106(3). The distillation can be performed using cloud resources (e.g., servers) in cloud 108. Note that, in some instances, the discussion below generically refers to any of the context-specific machine learning models 106(1), 106(2), or 106(3) as “context-specific machine learning model 106,” without a parenthetical.

In many cases, the base machine learning model is a large model, e.g., with many parameters that is not suitable for execution on a resource-constrained client device. The base machine learning model can be adapted for multiple contexts. For instance, as noted above, Copilot is an example of a base machine learning model that is adapted for code generation in multiple programming languages. As another example, a convolutional neural network such as ResNet-50 or NASNet Large could be adapted to recognize objects for different contexts, e.g., one context could involve recognizing different animal species in wildlife photographs and another context could involve recognizing organ damage in medical imagery.

Context-specific distillation 104 can involve transferring knowledge for a specific context from a large base machine learning model to a smaller context-specific machine learning model. For instance, if base machine learning model 102 is adapted to generate code in different programming languages, each context-specific machine learning model 106 could be adapted to generate code in a single one of those programming languages. Likewise, if base machine learning model 102 is adapted to recognize thousands of object types in images, each context-specific machine learning model could recognize a different subset of those object types.

### Model Deployment

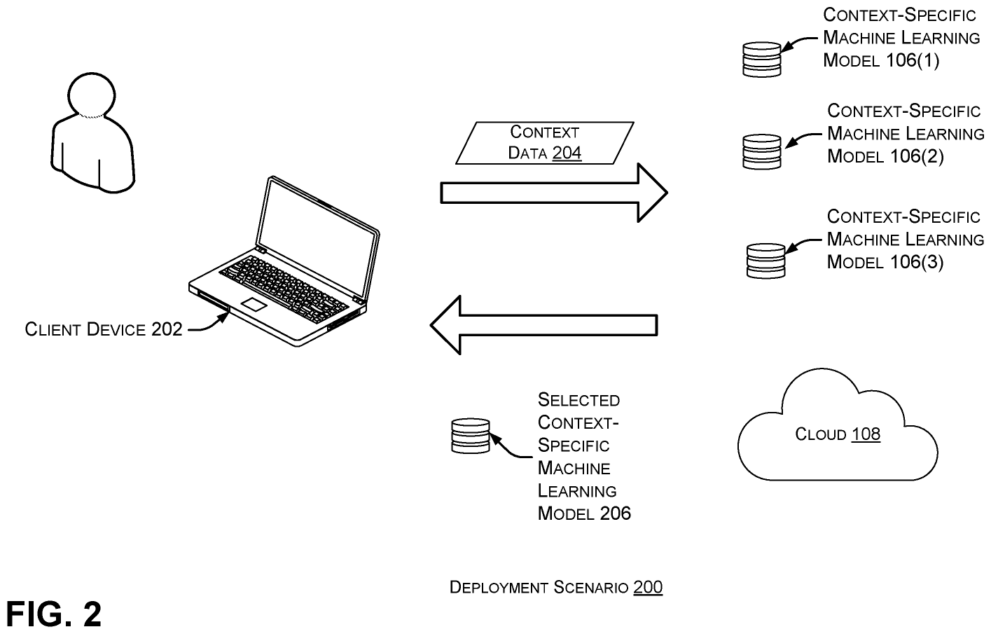

FIG. 2 illustrates a deployment scenario 200. A request is received from a client device 202 including context data 204. Based on the context data, a selected context-specific machine learning model 206 is selected from the available context-specific machine learning models 106(1), 106(2), and 106(3). The selected context-specific machine learning model is deployed from the cloud 108 to the client device.

For instance, if each context-specific machine learning model 106 is adapted to generate code in different programming languages, the context data 204 can include code snippets that can be employed to determine what programming language that a user of the client device 202 is currently coding in. If each context-specific machine learning model is adapted for recognizing different types of objects, then the context data can indicate what application a user of the client device 202 is employing, e.g., a medical imaging application vs. a social media application where the user frequently posts and views images of wildlife.

### Teaching Scenario

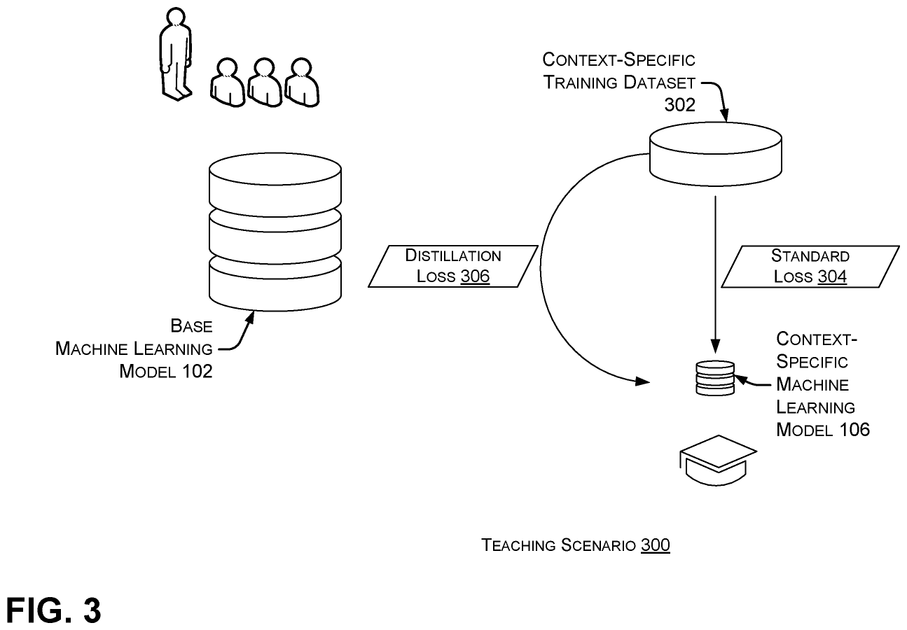

One way to implement knowledge distillation from a base machine learning model to a context-specific machine learning model involves employing the base machine learning model as a teacher and the context-specific machine learning model as a student. FIG. 3 illustrates a teaching scenario 300 for obtaining a context-specific machine learning model. Base machine learning model 102 and context-specific machine learning model 106 are both evaluated on a context-specific training dataset 302. Parameters of the context-specific machine learning model 106 are adjusted using a standard loss 304 as well as a distillation loss 306.

The standard loss 304 reflects how accurately the context-specific machine learning model 106 predicts values (e.g., labels) for examples in the context-specific training dataset 302. The distillation loss 306 reflects how closely the output of the context-specific machine learning model matches the output of the base machine learning model 102. The distillation loss for any individual training example can include a term that is based on the difference between the output distribution of the base machine learning model for that training example and the output distribution of the context-specific machine learning model for that training example.

For instance, assume a training example includes an image of a horse. If the base machine learning model 102 predicts that the image is a horse with a score of 0.7 and a zebra with a score of 0.3, then the distillation loss for that training example increases as the output distribution of the context-specific machine learning model 106 deviates further from 0.7 horse, 0.3 zebra. Training according to standard loss encourages the context-specific model to learn the correct labels from the training dataset, whereas training according to distillation loss encourages the context-specific model to replicate the output distribution of the base machine learning model.

In some cases, multiple student models can be derived from a given base machine learning model. For instance, the same student model architecture can be trained using distillation loss from the same base machine learning model, but using different context-specific datasets. In other words, teaching scenario 300 can be performed a first time using a first context-specific training dataset to train a first context-specific machine learning model, a second time using a second context-specific training dataset to train a second context-specific machine learning model, and so on, where each context-specific model has the same architecture. In other cases, however, the student models can have different architectures as well.

### Model Architecture Search

Generally speaking, it can be useful for the context-specific machine learning model to be smaller than the base machine learning model. One way to obtain a student model architecture is to manually select the architecture of the student model. Another way is to perform a neural architecture search using evolutionary approaches, reinforcement learning approaches, Bayesian optimization approaches, hill-climbing approaches, one-shot approaches, etc. The following discussion uses an evolutionary approach as a specific example of how the disclosed concepts can be employed for automated generation of a machine learning model to use as a context-specific student model. However, as discussed further below, the disclosed concepts can be readily incorporated into other approaches for generating machine learning models.

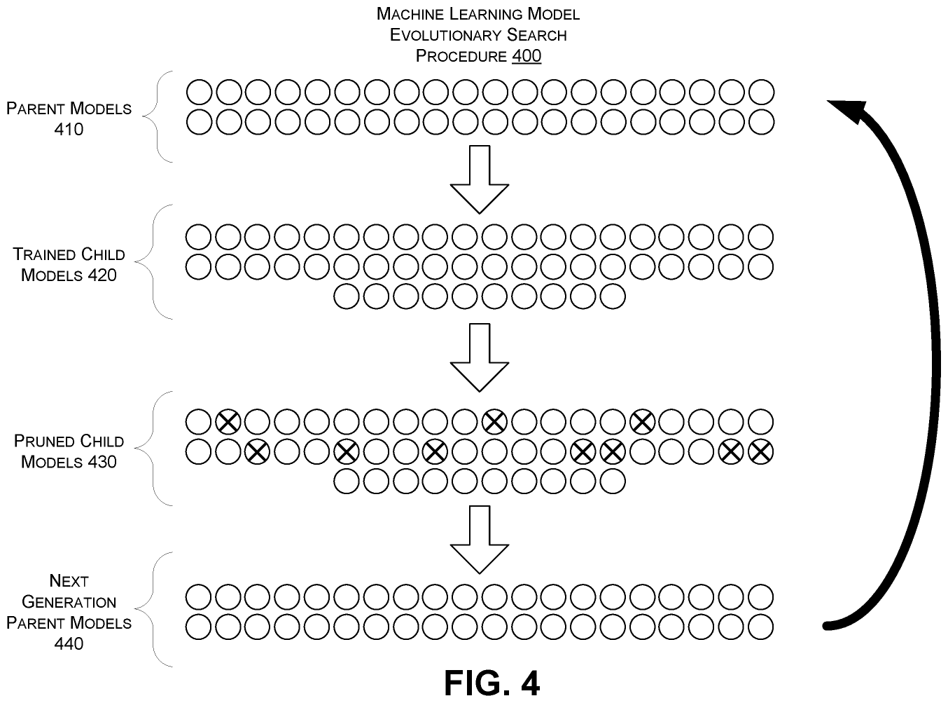

FIG. 4 illustrates an example machine learning model evolutionary search procedure 400 to determine an architecture to use for context-specific machine learning models 106. First, parent models 410 are modified and trained to include trained child models 420. As described more below, in some cases the parent models are modified subject to certain constraints, such as hardware limitations. For instance, the constraints can dictate that the modifications include inference operations that are supported by a target inference hardware architecture (e.g., a specific model of NPU) or that fit within memory (e.g., SRAM) constraints of the target inference hardware architecture. In addition, in some cases the parent models are modified by removing other inference operations that do not meet the constraints. Parent models can also be modified by adding or removing connections between individual inference operations.

Next, the trained child models 420 are pruned to obtain pruned child models 430. For instance, the trained child models can be pruned to remove individual child models that perform relatively less well than other child models with respect to one or more metrics. As discussed more below, the metrics can relate to loss or accuracy, latency, power consumption, memory utilization, etc. In some cases, the metrics can be determined using a distillation loss or “soft loss” value that is based on the difference between the output distribution produced by a given child model for a training example as compared to the base machine learning model when evaluating the same training example.

After model pruning, the remaining trained child models are designated as next generation parent models 440. Further iterations of the model search can be performed by training and pruning further child models until a stopping condition is reached, at which point a final model can be selected from the available child models.

### Example Model Modifications

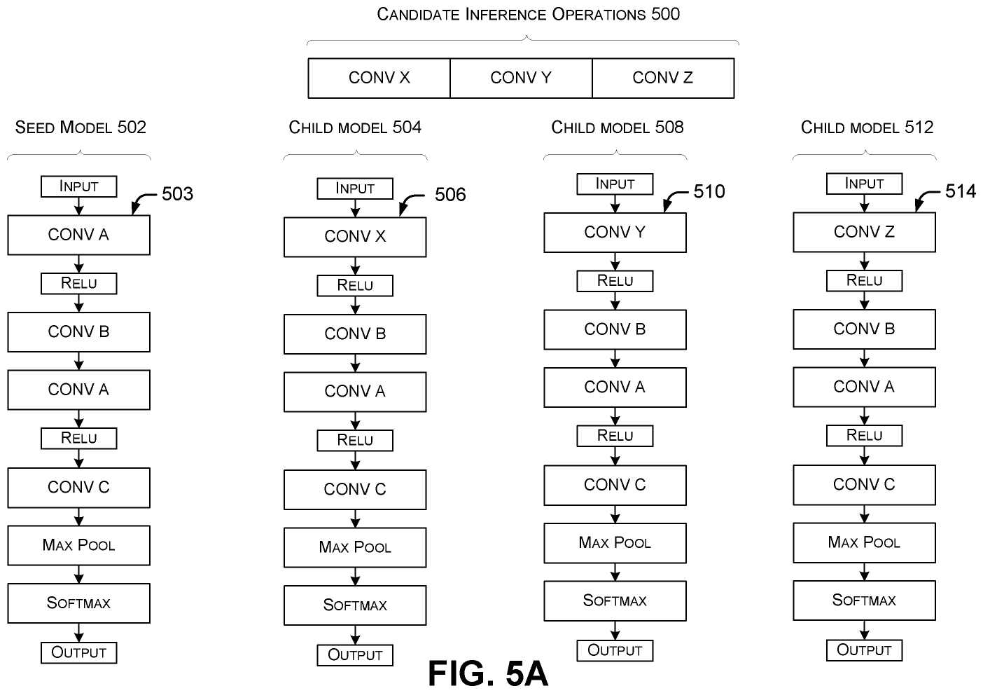

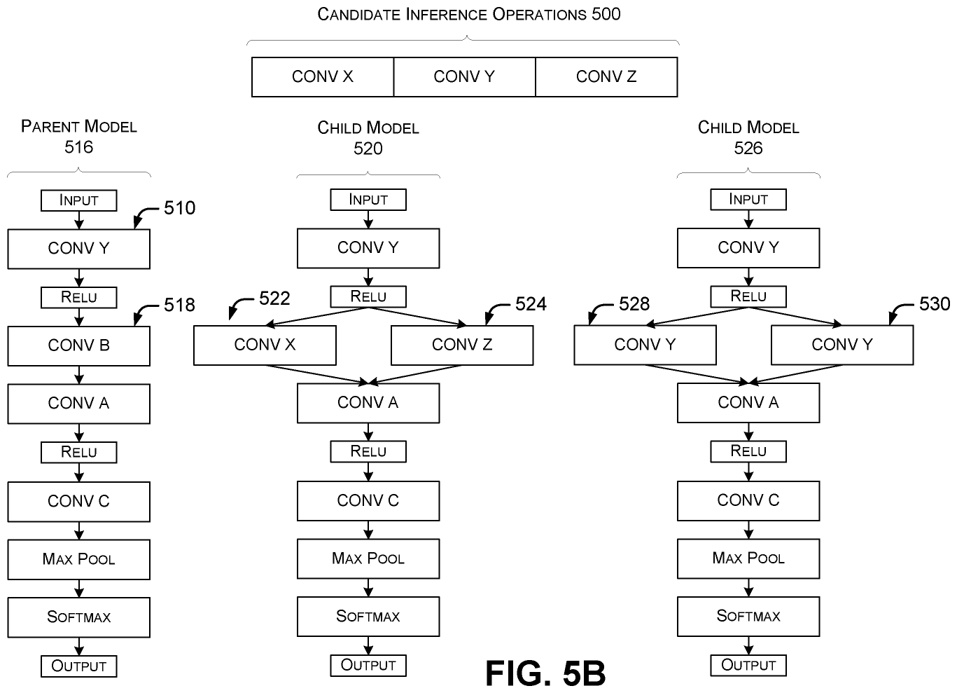

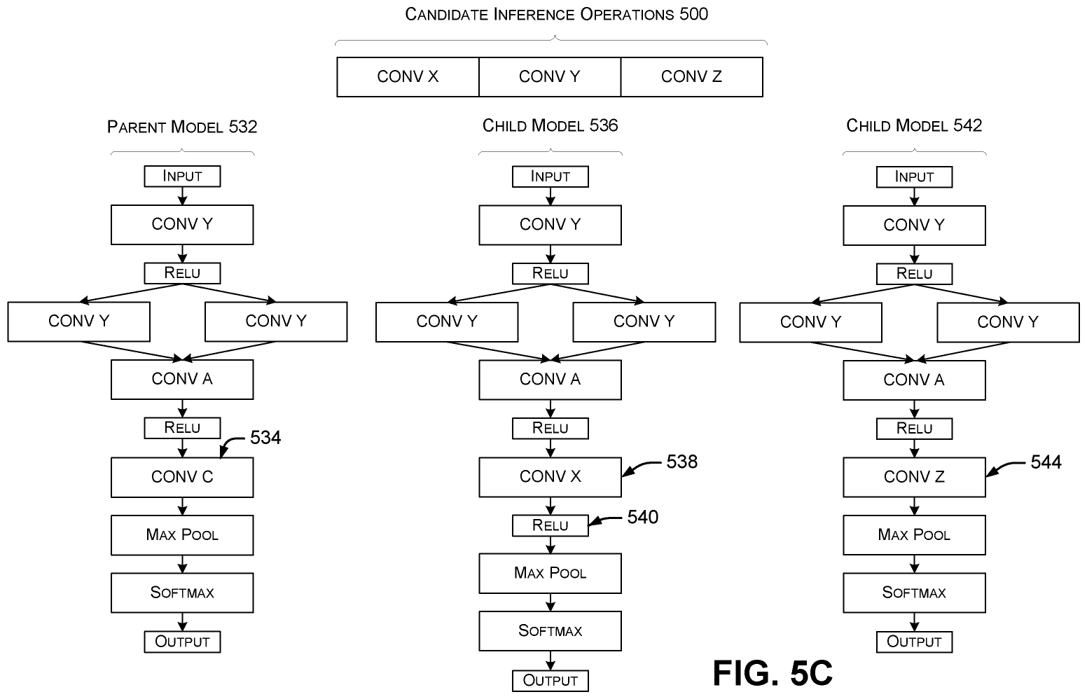

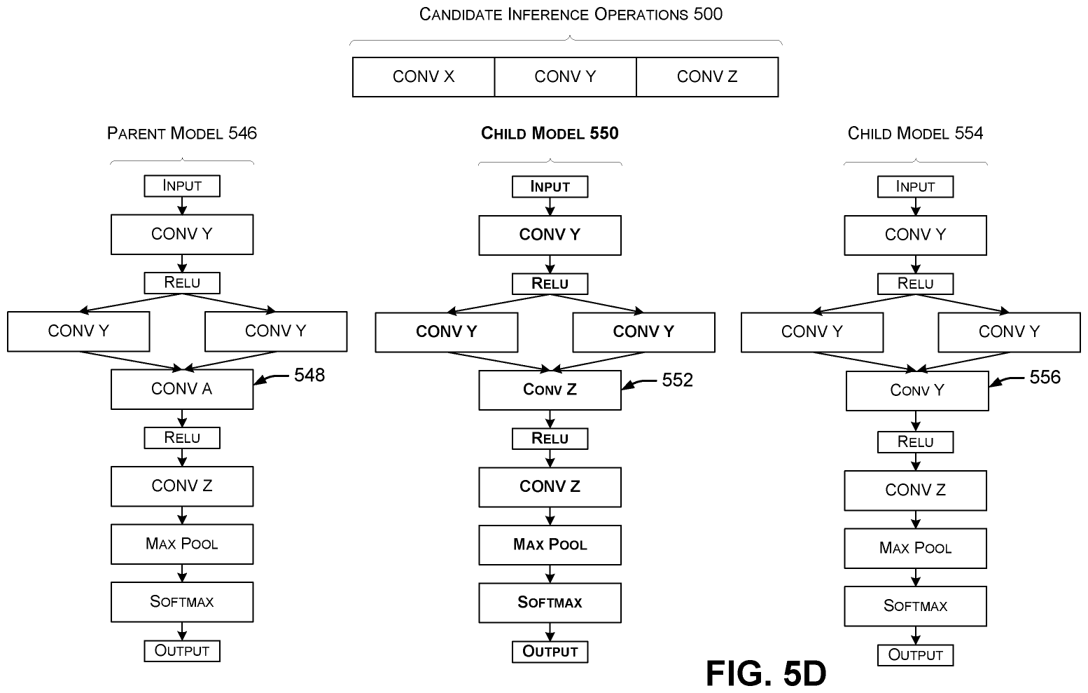

FIGS. 5A, 5B, 5C, and 5D illustrate example modifications that can be performed to transform parent models into child models. FIGS. 5A-5D convey these concepts using convolutional network architectures, but the concepts shown herein can be applied to other types of neural network architectures, such as transformer-based networks, long short-term (“LSTM”) networks, etc.

FIG. 5A shows candidate inference operations 500, which include three specific inference operations—CONV X, CONV Y, and CONV Z. In some cases, each candidate inference operation can be selected to meet a hardware constraint. As one example of a hardware constraint, each candidate inference operation can have a specified size that fits within the SRAM of a target inference processing unit architecture. As another example of a hardware constraint, each candidate convolution operation can have a specific input/output tensor size and/or kernel size that is supported by dedicated circuitry on a target inference processing unit architecture or otherwise runs more efficiently on the target inference processing unit architecture than on a conventional CPU. In other words, a given inference processing unit that implements the target inference hardware architecture has dedicated circuitry for performing convolution operations with those tensor and/or kernel sizes, e.g., potentially using a single machine instruction (e.g., opcode). The dedicated circuitry for implementing a given convolution operation can have parallel hardware nodes, each of which can perform a part of the convolution operation on a portion of input data to produce a portion of output data. The output data can be combined and further processed using further circuitry provided by the inference processing unit that implements the target hardware architecture.

Seed model 502 can be a model that was originally developed without considering the target inference architecture. For instance, seed model 502 can be a model that was developed manually or using automated techniques and is known to perform well for a particular task, such as a particular image processing operation (e.g., background segmentation, object recognition, etc.) or natural language processing operation (e.g., natural language understanding, natural language generation). As illustrated, seed model 502 includes three types of convolution operations, A, B, and C, that are not necessarily supported by the target hardware architecture. In other words, convolution operations A, B, and C may not fit within the SRAM of a given inference processing unit, and/or may have different tensor and/or kernel sizes that are not supported in hardware. Note that seed model 502 can be much smaller than the base machine learning model.

As described more below, multiple iterations of a machine learning model search procedure can be performed starting with seed model 502 as a parent model. In each iteration, one or more operations or connections between operations can be added or removed until a final model is generated. The final model can be adapted for execution on the target inference hardware architecture, e.g., because each operation fits in the SRAM of that target inference hardware architecture and/or is supported in hardware by the target inference hardware architecture.

In a first model search iteration, convolution A operation 503 of seed model 502 can be replaced to generate child models 504, 508, and 512. Child model 504 can be generated by replacing the convolution A operation with convolution X operation 506, child model 508 can be generated by replacing the convolution A operation with convolution Y operation 510, and child model 512 can be generated by replacing the convolution A operation with convolution Z operation 514. As described above, the respective child models can be trained and one or more of the child models selected as a parent model for the next generation of models. The child models can be trained on a context-specific training dataset using standard loss and/or distillation loss from a much larger base machine learning model.

Assume, for the purposes of example, that child model 508 is selected as a parent model for the next generation, redesignated as parent model 516 in FIG. 5B. This parent model can be modified by replacing convolution B operation 518 to generate child models 520 and 526. Child model 520 can be generated by replacing the convolution B operation with convolution X operation 522 and convolution Z operation 524. Child model 526 can be generated by replacing the convolution B operation with convolution Y operation 528 and convolution Y operation 530. As described above, the respective child models can be trained on the context-specific training dataset and one or more of the child models can be selected as a next-generation parent model.

Assume, for the purposes of example, that child model 526 is selected as the parent model for the next generation, redesignated as parent model 532 in FIG. 5C. This parent model can be modified by replacing convolution C operation 534 to generate child models 536 and 542. Child model 536 can be generated by replacing the convolution C operation with convolution X operation 538 and ReLu operation 540.

Child model 542 can be generated by replacing the convolution C operation with convolution Z operation 544.

Now, assume that child model 542 is selected as the parent model for the next generation, redesignated in FIG. 5D as parent model 546. This parent model can be modified by replacing convolution A operation 548 to generate child models 550 and 554. Child model 550 can be generated by replacing the convolution A operation with convolution Z operation 552. Child model 554 can be generated by replacing the convolution A operation with convolution Y operation 556.

At this point, a stopping condition may be reached and a final model selected from the models generated so far. For example, child model 550 may be selected as final model, shown in FIG. 5D by bold text. The final model can be output for execution on an inference processing unit to perform a particular task that the model has been trained to do. Thus, referring back to FIG. 5A, seed model 502 has been transformed into a final model that can perform the same task as the seed model, but using inference operations that meet hardware constraints relating to the target inference hardware architecture. Thus, the final model can provide similar functionality as the seed model while being suited for execution on the target inference hardware architecture.

While FIGS. 5A-5D convey how convolutional architectures can be searched using an evolutionary procedure, similar approaches can be employed for other times of architectures, such as transformer-based architectures. In the case of a transformer architecture, the search can consider different embedding sizes, different numbers/sizes of encoder and/or decoder layers, the number of attention heads, the dimensions of feed-forward or other layers in the model, etc. These characteristics of a transformer-based model can be modified to meet corresponding memory limitations and/or hardware operations supported by a given target architecture.

### Example Model Generation Workflow

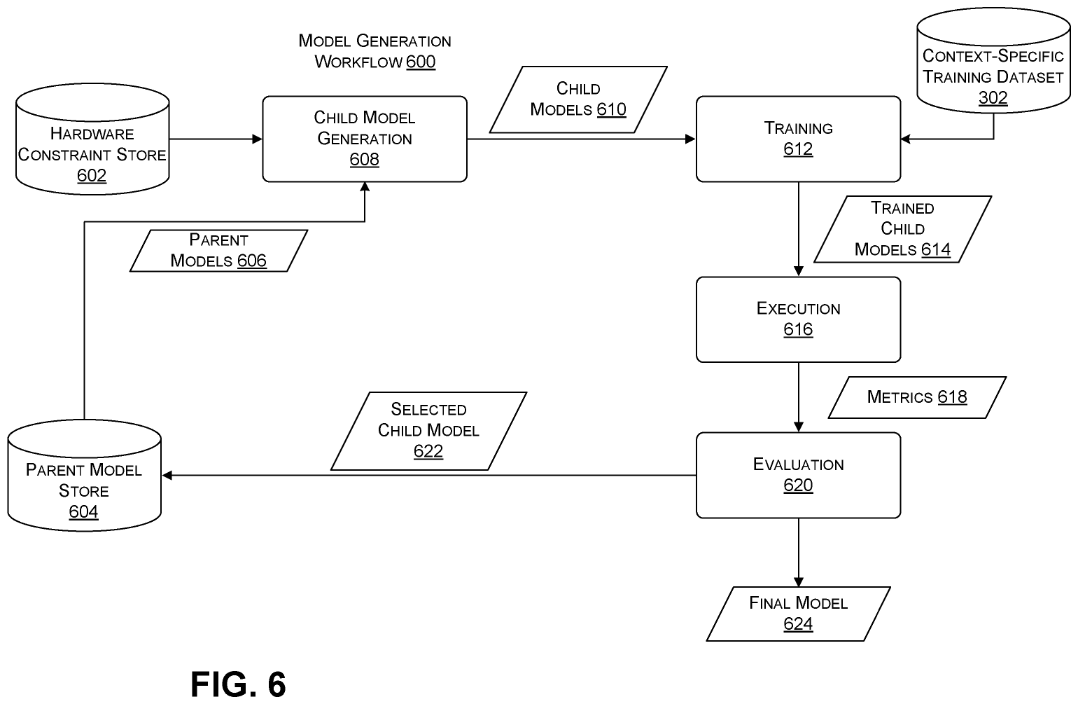

FIG. 6 illustrates an example model generation workflow 600 that can be employed to search a machine learning model space. Hardware constraint store 602 stores one or more hardware constraints, such as SRAM size or specific inference operations that are supported in hardware, such as convolution operations X, Y, and Z illustrated above in FIGS. 5A-D. Parent model store 604 stores parent models that can be replaced with new parent models over time, as described more below. In some cases, the parent model store is initialized using one or more seed models, e.g., that are selected based on their performance (e.g., accuracy) at a particular task. Subsequent generations of parent models can be used to populate the parent model store over time.

For each generation, one or more parent models 606 can be retrieved from the parent model store and input to child model generation 608. The child model generation can modify the parent models consistent with the constraints in the hardware constraint store 602 to produce child models 610. The child models can be trained at 612 to produce trained child models 614, e.g., using supervised learning, unsupervised learning, transfer learning, etc., with or without distillation loss from a base model. Training can be based on a context-specific training dataset 302, which can include training examples that are processed by each child model during training. In implementations where distillation loss is considered during model generation, the base machine learning model can also process each of the training examples in the context-specific training dataset to determine the distillation loss.

The trained child models can be executed at 616 to obtain metrics 618. For instance, the metrics can characterize accuracy or losses (standard or distillation) of the trained child models, latency (e.g., execution times) of the trained child models, power consumption or memory utilization of the trained child models, etc. The metrics can be used to evaluate the trained child models to identify selected child models 622. For instance, in some cases, the child models are selected based on a trade-off between two or more metrics, e.g., by selecting child models that have relatively low combined loss and relatively low power consumption. A similar approach can also be used to select a final model 624 upon reaching a stopping condition.

Child model generation 608 can involve replacing or adding operations and/or connections between operations, as shown above with respect to FIGS. 5A-5D. For instance, child model generation can involve random or deterministic approaches for selecting operations to add to parent models, operations to remove from child models, and/or connections to add or remove between individual operations. In some implementations, child model generation is constrained fully by the hardware constraints.

### Evaluating and Designating Child Models as Parents

As noted previously, certain child models are selected during evaluation 620 and added to the parent model store 604 for use as parent models in subsequent generations. One approach for deciding which child models to add to the parent model store involves using one or more metrics to predict which child models are likely to produce offspring that, in subsequent iterations, will exhibit improvements relative to previously-discovered models. Generally, the metrics can consider factors such as the standard and/or deviation loss or accuracy of a given child model, latency of a given child model, power consumption of a given child model, computing resource consumption (e.g., memory consumption) of a given child model, and so on. Child models that exhibit characteristics such as relatively low loss or high accuracy, low latency, low power consumption, and/or low computing resource consumption can be favored for selection as parent models in the next generation.

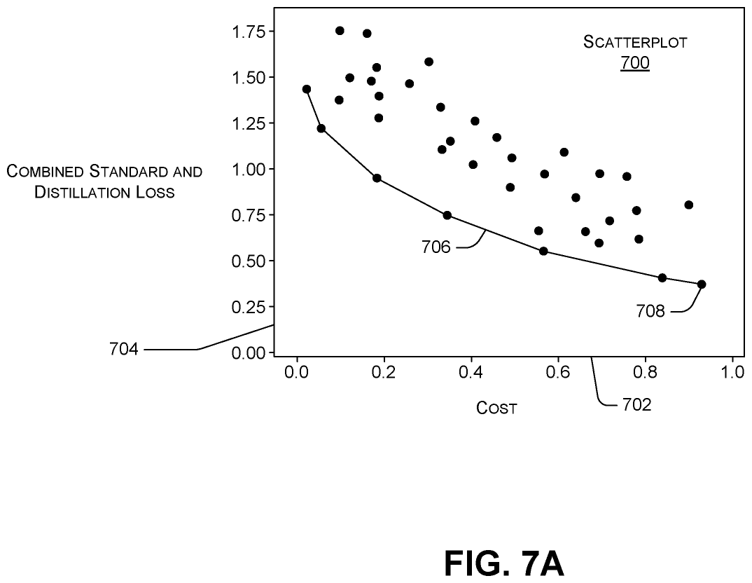

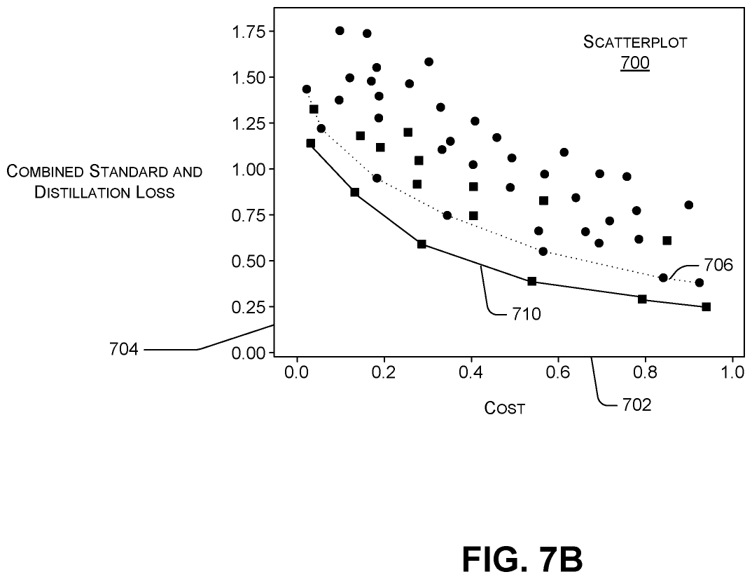

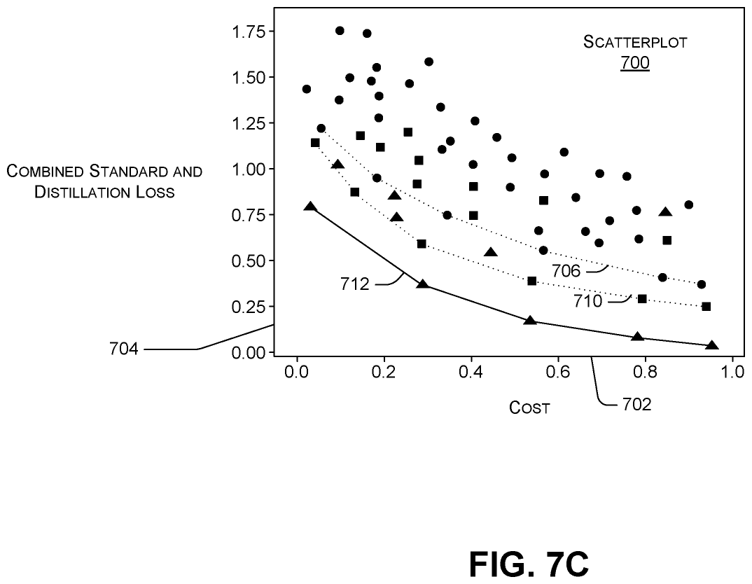

One specific approach to selecting child models for the parent pool is shown herein with respect to FIG. 7A. This figure illustrates an example scatterplot 700 for various trained models. For each child model that completes training, the cost of that child model can be computed and plotted on x-axis 702, where the cost can be defined based on latency, power consumption, computing resource consumption, etc. In some cases, the cost can be normalized to a number between 0 and 1, as shown in FIG. 7A. In addition, the loss of that child model can be computed and plotted on y-axis 704. Here, a combined loss function that considers both the standard loss and the distillation loss can be employed, e.g., a weighted sum of these two values. Once all models for a given iteration have been plotted, a lower convex hull 706 can be computed from the plotted values. Note, however, that some approaches can employ only distillation loss or only standard loss to select which child models are selected as parent models for subsequent generations.

In addition, note that distillation loss can also be employed to partially train child models and to update parameters of the child models. In other words, distillation can be employed for two distinct purposes—to select which child models are employed as parent models for the next generation of model growth, and to update model parameters during training iterations. For instance, partial training of a child model can be performed using only distillation loss as a loss function or using a weighted combination of distillation and standard loss as a loss function.

The lower convex hull 706 can be used as a mechanism to decide whether a given child model is added to the parent model pool. For example, a child model on the lower convex hull can be added to the parent model pool with a probability defined using the following specific algorithm. If m₁ and m₂ are two adjacent models on the hull, with costs c₁ and c₂ (c₁<c₂), then the probability weight of m₁ can be set proportionally to c₂-c₁. The most accurate model according to the combined loss function, which has no following model on the curve, can be selected for inclusion within the parent model pool with probability 0.5. In FIG. 7A, the most accurate model is model 708, since this model has the lowest combined loss.

Generally, a lower convex hull is a subset of the Pareto frontier, and thus another approach is to select child models on the Pareto frontier for inclusion into the parent pool. Either approach can provide good performance for selecting child models to add to the parent model pool. One way to view the lower convex hull and/or the Pareto frontier is as follows. A given model on the lower convex hull or Pareto frontier cannot be improved with respect to one metric by moving to another model on the lower convex hull/Pareto frontier without degrading the other metric.

Note that the same models may have different validation errors due to randomness in forming stochastic gradients. As a consequence, the lower convex hull or Pareto frontier can be relaxed with a multiplicative bandwidth. Thus, a child model whose validation error is within (1+y) times the lower convex hull validation error at the same computational cost can be considered to be on the lower convex hull and can be chosen as a parent. Some implementations can be set to y=0.025. This approach allows certain child models that are proximate to the lower convex hull, yet not strictly located thereon, to still be designated as parent models.

Other approaches may also be used to allow child models that have locations within a predetermined vicinity of the lower convex hull to be selected as parent models. For example, some implementations can define a threshold distance from the lower convex hull, and allow child models within the threshold distance of the lower convex hull to be selected as parent models. This is just one of various approaches that can be used to select a subset of one or more child models as a parent model, based on one or more metrics.

FIG. 7A shows models that have completed training as black dots. For purposes of explanation, assume that FIG. 7A represents the state of scatterplot 700 after iteration N. One or more of the child models on or near lower convex hull 706 can be selected as parent models for a subsequent iteration N+1, where additional operations be added from further child models, as discussed above.

FIG. 7B shows scatterplot 700 in a subsequent state after iteration N+1. Child models trained during iteration N+1 are shown in FIG. 7B using squares. A new lower convex hull 710 can be computed. Previous lower convex hull 706 is shown as a dotted line to illustrate movement of the lower convex hull downward in iteration N+1.

Again, one or more of the child models in or near lower convex hull 710 can be selected for a subsequent iteration N+2. Child models trained during iteration N+2 are shown in FIG. 7C as triangles. A new lower convex hull 712 can be computed, and previous lower convex hulls 706 and 710 are shown in dotted lines to illustrate their position relative to lower convex hull 712.

One way to view the approach shown in FIGS. 7A-7C is a greedy approach to finding cost-efficient predictors. Note that this is a multi-objective approach, considering both loss/accuracy as well as model performance with respect to latency, power consumption, or resource utilization. Alternative implementations might use different and/or additional metrics, e.g., multi-dimensional plots of three or more metrics, an objective function defined over one or more metrics, etc.

The approach set forth above generally grows networks using a randomized approach. However, instead of a purely random approach which might be computationally infeasible, the approach is guided by favoring the selection of known good models as a basis for further modification. As noted previously, training a model from scratch can be very computationally intensive. For example, a training data set might include millions of training data items, and a given model might need to be trained over several training epochs before convergence. A training epoch can involve one forward propagation and one backpropagation operation through an entire model for each data item in the training data set.

The approach set forth above offers various benefits relative to conventional approaches for automated model generation. Note that not every child model is used as a parent model for subsequent iterations. Rather, by using a subset of child models that occur along the lower convex hull as new parent models, the disclosed implementations start each new iteration with child model structures that inherit the parent model structure of known good models. This allows subsequent iterations to proceed without training models that occupy a significant portion of the search space that is far away from the lower convex hull, and can save a tremendous amount of training time. In addition, by using not only accuracy but cost as criteria for selecting which child models to use as new parent models, the disclosed implementations disfavor the generation of new models that tend to have high latency or consume significant power or computational resources.

Recall that previous techniques for automated generation of machine learning models generally do not consider distillation loss. In contrast, the techniques described herein can generate model architectures that meet specific hardware constraints while considering distillation loss relative to a known base machine learning model. In addition, the search can also consider other characteristics of the resulting models, such as latency, power consumption, and resource utilization.

In some cases, the same final architecture is employed as a student model and trained on different context-specific training datasets to obtain different context-specific machine learning models. In other cases, the search can be performed using different context-specific training datasets with distillation loss as a metric for evaluation. In this case, the resulting final architectures can vary, e.g., different context-specific models have not only different weights and bias values, but context-specific architectures found via the neural architecture search.

### Simulation and Emulation

In some case, the techniques described above can be performed by simulating the target hardware using general-purpose hardware, without executing the models on hardware that implements the target inference hardware architecture and without emulating the target inference hardware architecture. Simulating execution of a model can involve approximating the functionality of a given target hardware architecture without directly implementing the underlying inference operations that are supported by the target hardware architecture. Using simulation, it is still possible to predict the accuracy of a given model, because general-purpose hardware can be used to simulate and execute operations that are mathematically or logically equivalent to those supported by the target inference hardware architecture.

For instance, on a general-purpose CPU, it may take hundreds or thousands of operations and processing cycles to implement a convolution or matrix operation that can be executed using a single operation by an NPU, in only a few processing cycles. However, because the operations are mathematically or logically equivalent (or at least approximately so), the accuracy or loss of a given model can still be estimated on the CPU. Thus, a general CPU can be used to transform an initial seed model architecture with operations that are not supported by a target inference hardware architecture into a final model that is fully supported by the target inference hardware architecture. Even assuming simulation on the CPU cannot, without emulation, estimate the performance of the final model with respect to latency, power consumption, or resource utilization, it is nevertheless likely that the final model will still exhibit significant improvements relative to the seed model given that the final model can leverage the efficiencies provided by the target inference hardware architecture by using hardware-supported operations and/or layers that fit within memory constraints of the target architecture.

In further implementations, hardware emulation of individual operations supported by the target inference hardware architecture can further guide the search. In hardware emulation, a CPU can implement operations that directly correspond to the inference operations of a given model. In other words, the CPU can replicate the target hardware architecture by mapping each inference operation in a given model to a corresponding set of CPU instructions that are designated for emulating that inference operation. By using emulation, performance information about each model can be inferred. For instance, the overall latency, power consumption, and/or resource utilization of a given model can be estimated based on the emulation. This allows for a multi-objective search to be performed where child models can be selected as parents in the next generation based not only on accuracy or loss, but also the performance of each model.

### Alternative Search Techniques

The concepts described herein are conveyed above using an evolutionary search procedure to illustrate how a machine learning model space can be searched while considering the availability of hardware-supported inference operations. However, the specific techniques described above can be readily extended to various other approaches for automated generation of machine learning model architectures.

For instance, consider approaches that employ reinforcement learning to find new model architectures. In some implementations, an exploration strategy can be provided that encourages searching of model architectures that meet hardware constraints such as SRAM limitations or having hardware supported operations. As another example, consider approaches that employ Bayesian optimization to explore new machine learning models. In some implementations, an acquisition function can be defined that considers hardware constraints in determining which models to explore. Similar approaches can be employed for one-shot model generation, e.g., by defining a supernetwork having candidate inference operations that meet hardware constraints, training those operations together, and subsequently culling the supernetwork to select a particular path through the supernetwork as the final model.

### Pruning Scenario

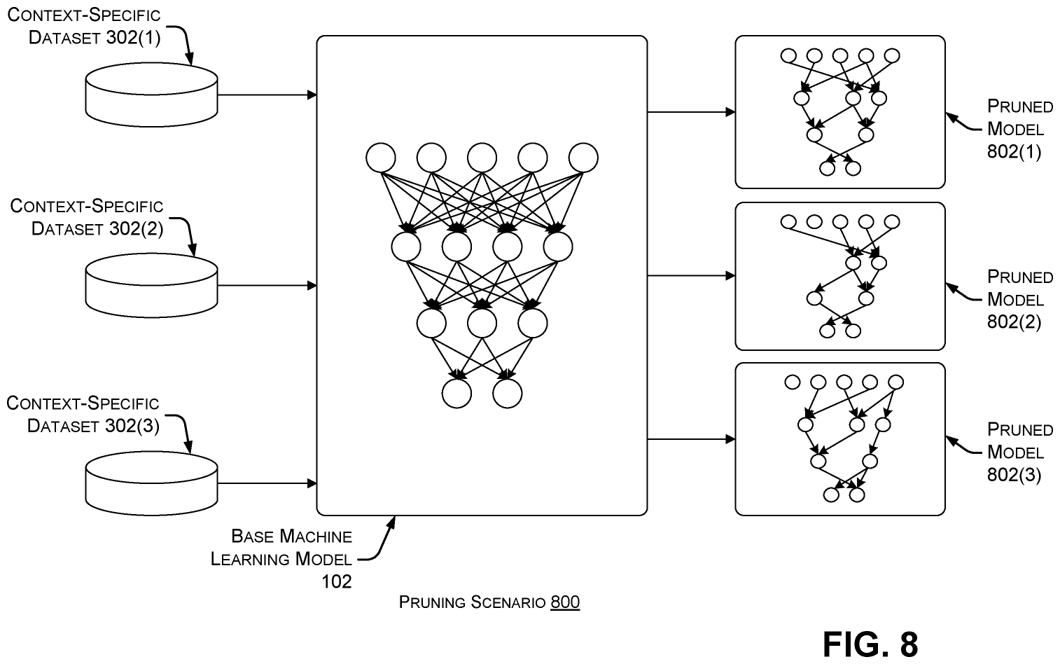

Another way to implement knowledge distillation from a base machine learning model to a context-specific machine learning model involves pruning the base machine learning model to result in a smaller context-specific machine learning model. FIG. 8 illustrates a pruning scenario 800 for obtaining a context-specific machine learning model. Different context-specific training datasets 302(1), 302(2), and 302(3) are processed using base machine learning model 102 to obtain pruned models 802(1), 802(2), and 802(3).

One way to prune a model involves magnitude pruning, where the model is executed on a given context-specific dataset and parameters with relatively low magnitudes are pruned from the model. Another way to prune a model involves gradient pruning, where parameters are pruned based on the error gradient for a given training dataset. Generally, pruning involves changing individual parameters (e.g., weights) to zero so that the parameters can be easily compressed and implemented using a simple no-op in inference hardware. Pruning can be done in a structured or unstructured fashion. In unstructured pruning, weights are pruned individually. In structured pruning, entire layers (e.g., convolutional filters, attention layers, etc.) can be pruned at once.

Note that each pruned model can have a different architecture than the initial model. In other words, different layers can be removed and/or connections dropped from individual models. In the case of convolutional models, for instance, a layer can be effectively removed by zeroing out all parameters of a given convolutional filter. In the case of a transformer model, the initial model could be pruned by removing one or more attention heads, encoder layers, or decoder layers.

In some cases, the teaching and pruning scenarios can be combined. First, a search is performed to identify a suitable architecture. Then, respective instances of that architecture are trained using different context-specific training datasets to obtain context-specific machine learning models. Further training on context-specific data can be performed to perform individualized pruning of the context-specific machine learning models.

### Example System

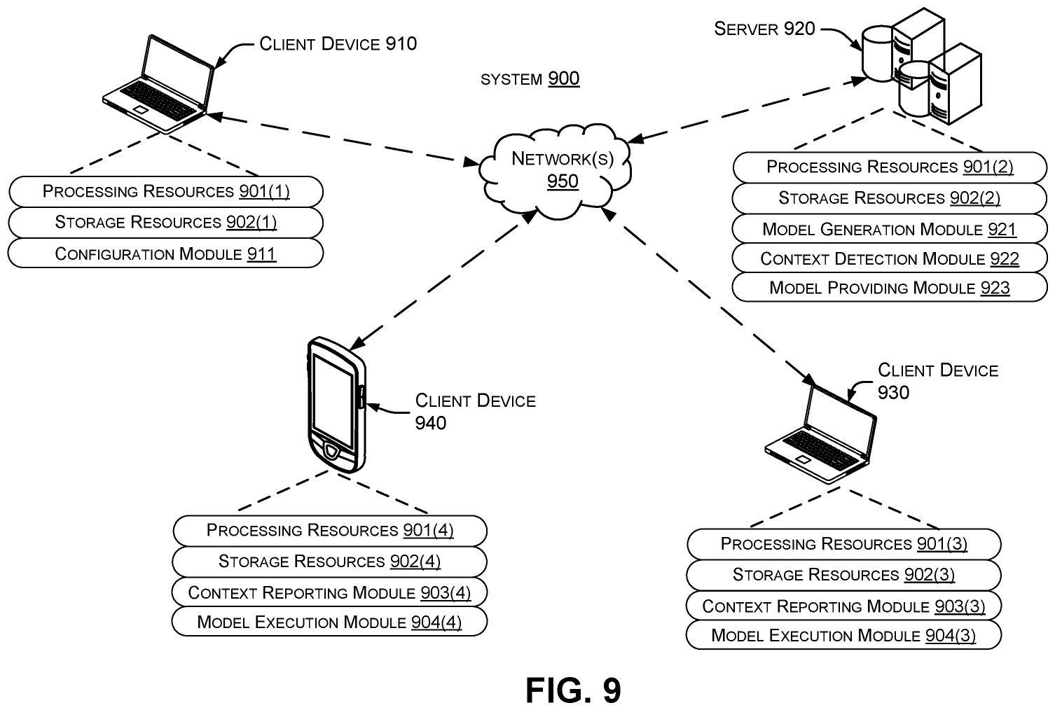

The present implementations can be performed in various scenarios on various devices. FIG. 9 shows an example system 900 in which the present implementations can be employed, as discussed more below.

As shown in FIG. 9, system 900 includes a client device 910, a server 920, a client device 930, and a client device 940, connected by one or more network(s) 950. Note that the client devices can be embodied both as mobile devices such as smart phones or tablets, as well as stationary devices such as desktops, server devices, etc.

Likewise, the servers can be implemented using various types of computing devices. In some cases, any of the devices shown in FIG. 9, but particularly the servers, can be implemented in data centers, server farms, etc.

Certain components of the devices shown in FIG. 9 may be referred to herein by parenthetical reference numbers. For the purposes of the following description, the parenthetical (1) indicates an occurrence of a given component on client device 910, (2) indicates an occurrence of a given component on server 920, (3) indicates an occurrence on client device 930, and (4) indicates an occurrence on client device 940. Unless identifying a specific instance of a given component, this document will refer generally to the components without the parenthetical.

Generally, the devices 910, 920, 930, and/or 940 may have respective processing resources 901 and storage resources 902, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 910 can include a configuration module 911 that can interact with a model generation module 921 on server 920. Generally speaking, the configuration module can provide certain configuration parameters to the model generation module. The model generation module uses these configuration parameters to perform model generation as discussed herein. The model generation module can derive context-specific models from a base machine learning model. The context detection module 922 can detect the context on each client device. The model providing module 923 can provide different context-specific machine learning models to each client device depending on context detected based on respective context data received from each client device.

Client device 930 and client device 940 can have respective instances of a context reporting module 903 and a model execution module 904. For instance, the context reporting modules can send context data to server 920, which can be processed by the context detection module 922 to predict the current context on a given client device. Model execution module 904 can execute the context-specific machine learning model returned by the server 920 after detecting the context.

### Context Detection

In some cases, the context detection module 922 can detect the context of a given client device based on manual input by a user. For instance, a user could select C++ as a programming language manually. In other cases, context detection can be performed automatically. For instance, certain programming languages tend to use certain operators more than others, e.g., the use of sigils such as “@” and “$” could imply that a user is programming in Perl, whereas the use of many parentheses could imply that a user is programming in Lisp. Thus, in some cases, the client device can send context data to the server 920, e.g., code snippets, and the server can detect the specific language being used on the client device. In other cases, automatic context detection can be performed on the client device.

As another example, a user might be programming in Java and start doing some statistics work. In this case, the context detection could look for libraries being used by the user (e.g., statistical libraries) as well as operations (e.g., many mathematical operations). A context-specific machine learning model for Java statistics code generation could be provided to the user at this time. Later, the user might start doing some Java programming to interface with a database, and the context detection could identify that the user is employing SQL statements in certain function calls. Then, a context-specific machine learning model for Java database development could be provided to the user. Both context-specific machine learning models can be adapted to generate Java code, but for different programming scenarios.

In the case of image processing, a user might start by employing a social media application to post pictures of their pets online. The user's posts might include natural language text that could imply a pet context, e.g., words like “puppy,” “Rover,” and “Siamese” could allow an automated context detection algorithm to select a context-specific image processing model to recognize types of pets in images. Later, the user might start using a medical application and using natural language text such as “liver” or “CT scan,” and the automated context detection algorithm could provide a context-specific image processing model for recognizing objects in medical images responsive to detecting that the user's device has switched to another context.

### Compression and Decompression

In some cases, processing resources 901(3) and 901(4) can include a conventional CPU as well as an inference processing unit such as an NPU. In such a case, the storage resources 902(3) and 902(4) can include storage resources for the CPU, such as a solid state hard drive and/or main memory (RAM), as well as an inference processing unit memory, e.g., an internal memory of the NPU (SRAM).

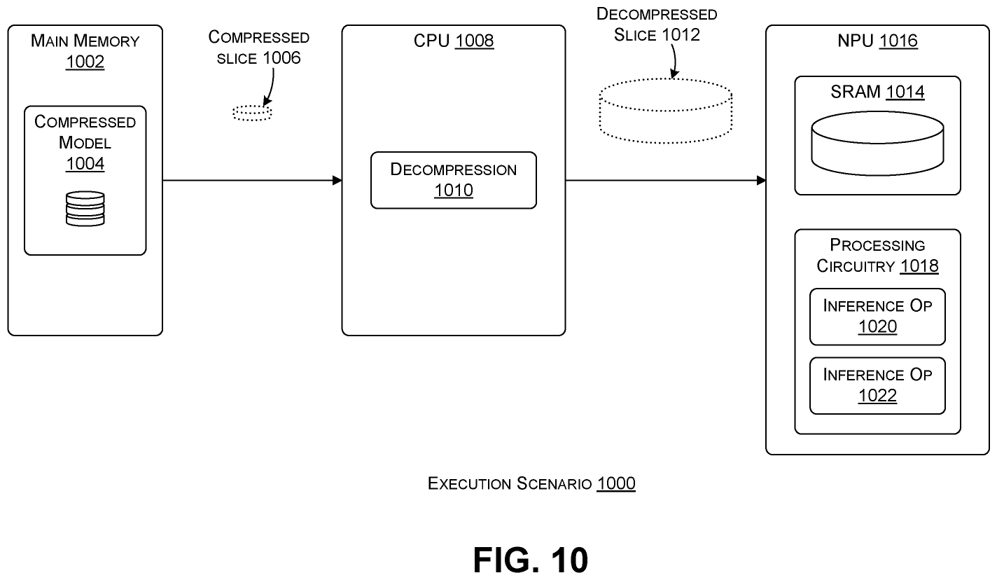

FIG. 10 shows an example execution scenario 1000 where a main memory 1002 of a client device stores a compressed model 1004. For example, the compressed model can be distributed to the client device by server 920. The model can be compressed by server 920 in “slices” to obtain a compressed version, where each slice can include parameters of a different layer, such as a convolutional layer, an attention layer, an encoding or decoding layer, and so on. For example, each layer of a given model can be compressed on the server using ZIP or another compression algorithm. Recall that some implementations can partially zero out parameter matrices during pruning, and long runs of the same value such as zeros allow for effective compression, e.g., a high compression ratio.

A CPU 1008 can retrieve a compressed slice 1006 from main memory 1002 and perform decompression 1010 on that slice to obtain a decompressed slice 1012. The decompressed slice can be loaded into SRAM 1014 of an NPU 1016. The NPU can use processing circuitry 1018 to perform individual operations on the decompressed slice, e.g., inference operations 1020 and 1022. This process can be repeated for each slice of the model until a final result is obtained.

### Example Graphical Interface

As noted above, the configuration module 911 on client device 910 can provide initial configuration parameters to the model generation module 921. The model generation module 921 can derive one or more context-specific machine learning models from a base machine learning model according to the configuration parameters provided by the configuration module.

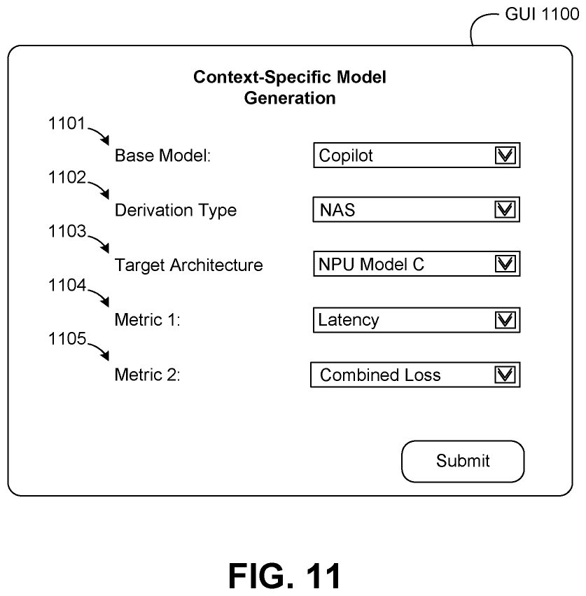

FIG. 11 illustrates an example configuration graphical user interface (“GUI”) 1100 that can be presented on client device 910 for a user to define these configuration parameters. Base model element 1101 allows the user to specify what base model should be used to derive context-specific models. In FIG. 11, the user is shown having selected a Copilot model, which is a large transformer-based model for generating programming code.

Derivation type element 1102 allows the user to specify what type of derivation to employ. Here, the user has selected NAS, e.g., a neural architecture search. Other options can include a pruning-only option and/or a NAS plus pruning option. When the user selects a NAS option, model generation module 921 may provide a default neural network structure for use as a generic seed model. Other options can include a randomly-generated model, where the module generation module selects a random model structure for use as the seed model. Another option is for the user to navigate to an existing seed model that is known to provide relatively good performance for a specific task. In this case, the configuration module 911 can upload the designated seed model to the model generation module for use as the seed model.

Target architecture element 1103 allows the user to select a target inference hardware architecture to guide the search. In FIG. 11, the user has selected NPU Model C, which may have a specific SRAM size and/or dedicated circuitry for performing specific operations of a specific inference hardware architecture. The model generation module can perform an architecture search under the constraint that each layer fits in the SRAM and/or matches one of the inference operations supported by the circuitry of NPU model C.

Metric 1 element 1104 allows the user to specify a first metric for evaluating models, and metric 2 element 1105 allows the user to specify a second metric. Here, the user has selected latency as the first metric and combined loss as the second metric. In other words, the user wishes to search the space of available model architectures that will exhibit relatively low latency while having relatively low combined loss, where combined loss is a function defined using both standard loss and derivation loss relative to a base machine learning model when executed on a context-specific training dataset.

Note that the configuration parameters shown in FIG. 11 are merely exemplary, and various other implementations are contemplated. For example, in some cases, the GUI can provide an element that allows a user to specify the location of a given context-specific training dataset to employ for NAS or pruning-based derivation. As another example, the GUI can provide an element that allows a user to specify a budget for an architecture search, e.g., a specified number of GPU days to employ as a stopping condition. As another example, the GUI can provide an element that allows a user to define respective weights for standard loss and derivation loss on a context-specific training dataset. Thus, if the user weights derivation loss relatively higher than standard loss, the search will tend to prioritize finding model architectures that approximate the performance of the base machine learning model. On the other hand, fi the user weights derivation loss relatively lower than standard loss, the search will tend to prioritize finding model architectures that perform well at matching labels from the context-specific training dataset.

Also, note that some implementations may provide one or more GUIs to show progress of model search. For example, some implementations may generate GUIs showing scatterplot 700 changing across different iterations of model growth in a manner similar to that shown in FIGS. 7A, 7B, and/or 7C. Other implementations may show graphical representations of individual models as they are generated.

### Method for Providing a Context-Specific Machine Learning Model

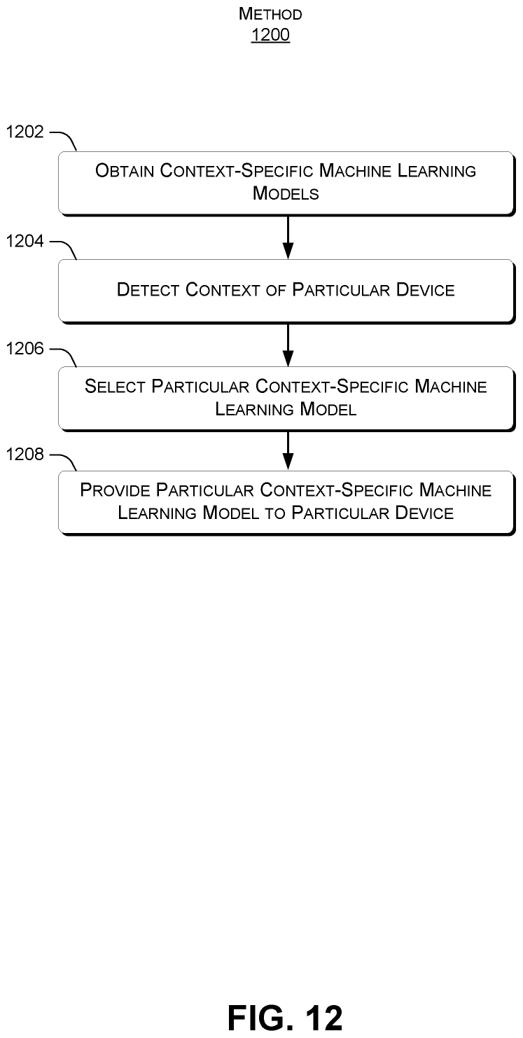

FIG. 12 illustrates an example method 1200, consistent with some implementations of the present concepts. Method 1200 can be implemented on many different types of devices, e.g., by one or more cloud servers, by a client device such as a laptop, tablet, or smartphone, or by combinations of one or more servers, client devices, etc.

Method 1200 begins at block 1202, where a plurality of context-specific machine learning models are obtained. As noted previously, the context-specific machine learning models can be derived from a larger base machine learning model that is adapted to different contexts.

Method 1200 continues at block 1204, where a context of a particular device is detected. As noted previously, in some cases the context is manually identified by a user. In other cases, the context is detected automatically by using an automated context prediction algorithm. For instance, an SVM or neural network classifier could classify programming code into different programming languages or different programming scenarios (e.g., statistical programs vs. database programs).

Method 1200 continues at block 1206, where a particular context-specific machine learning model is selected. The particular context-specific machine learning model can be a model that is derived from the base machine learning model and adapted to the particular context using context-specific training data.

Method 1200 continues at block 1208, where the particular context-specific machine learning model is provided to the particular device. For instance, the particular context-specific machine learning model can be sent from a cloud server to a client device for usage while the client device remains in the particular context. In some cases, block 1208 can involve temporarily executing either the particular context-specific machine learning model or the full base machine learning model on a cloud server for a period of time until the particular device is able to begin locally executing the particular context-specific machine learning model. This approach ensures that the functionality of the model remains available to the particular device via the cloud server after the change in context, e.g., during the time when the particular device is downloading the particular context-specific machine learning model from the cloud.

### Method for Generating Context-Specific Machine Learning Models

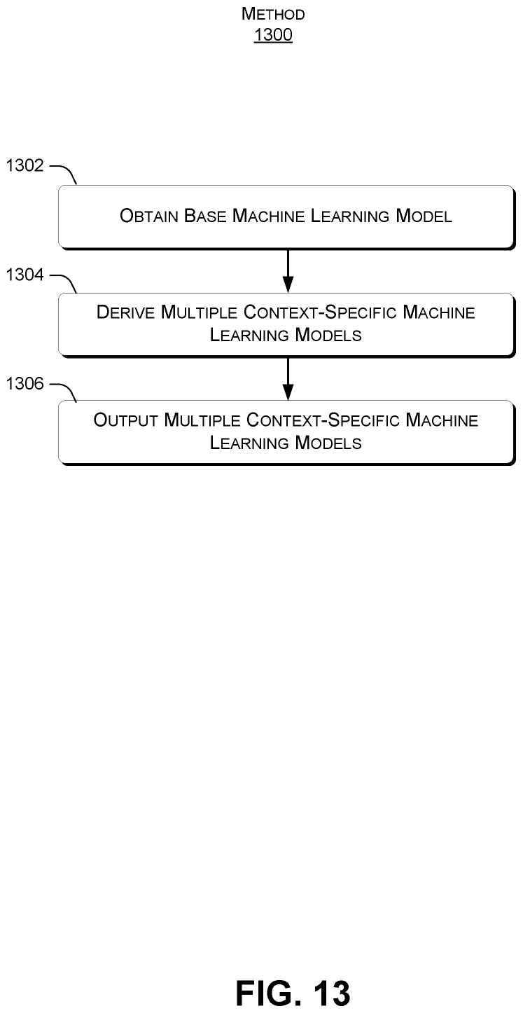

FIG. 13 illustrates an example method 1300, consistent with some implementations of the present concepts. Method 1300 can be implemented on many different types of devices, e.g., by one or more cloud servers, by a client device such as a laptop, tablet, or smartphone, or by combinations of one or more servers, client devices, etc.

Method 1300 begins at block 1302, where a base machine learning model is obtained. The base machine learning model can be a large model, such as BLOOM, GPT-3, ResNet-50, or NASNet Large, that has been adapted to multiple different contexts when received.

Method 1300 continues at block 1304, where multiple context-specific machine learning models are derived from the base machine learning model. As noted previously, one way to derive the context-specific machine learning models is by using the base machine learning model as a teacher, where the context-specific machine learning models and the base machine learning model are executed on respective context-specific training datasets to transfer knowledge from the base machine learning model to the context-specific machine learning models. Knowledge can be transferred by adjusting parameters of a given context-specific machine learning models based on a loss function that considers the difference in respective output distributions of the base machine learning model and a given context-specific machine learning model. Another way to derive the context-specific machine learning models is to prune parameters of the base machine learning model. The base machine learning model can be evaluated on context-specific training dataset to determine which parameters to prune.

Method 1300 continues at block 1306, where the multiple context-specific machine learning models are output. For instance, in some cases, the context-specific machine learning models are stored on a cloud server for subsequent distribution to individual client devices on a context-specific basis.

### Method for Executing a Context-Specific Machine Learning Model

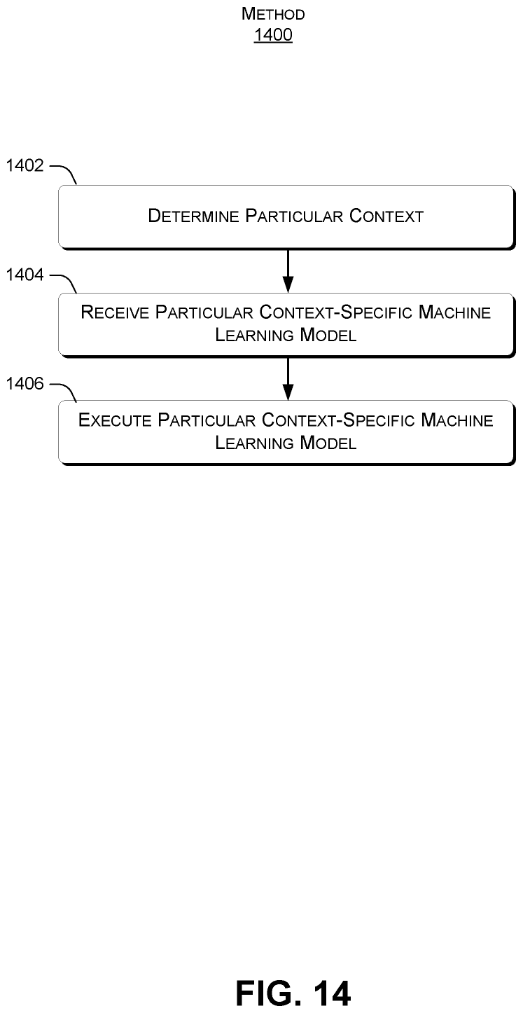

FIG. 14 illustrates an example method 1400, consistent with some implementations of the present concepts. Method 1400 can be implemented on many different types of devices, e.g., by one or more cloud servers, by a client device such as a laptop, tablet, or smartphone, or by combinations of one or more servers, client devices, etc.

Method 1400 begins at block 1402, where a particular context of a computing device is detected. For instance, context detection can be performed locally on the computing device, or remotely on a server.

Method 1400 continues at block 1404, where a particular context-specific machine learning model adapted for the particular context is received. In some cases, the particular context-specific machine learning model is compressed into individual slices when received.

Method 1400 continues at block 1406, where the particular context-specific machine learning model is executed. In some cases, execution can involve decompressing individual slices of the model using a CPU, loading the individual slices of the model into the memory of an inference processing unit, and performing hardware inference operations on data using the decompressed slices until a final result is obtained and output back to the CPU.

### Additional Use Case Details

As noted above, the disclosed techniques can be employed to derive context-specific machine learning models for a wide range of applications. In a code generation scenario, users may input descriptions of code functionality, e.g., docstrings, comments, etc. A context-specific machine learning model can output code that performs the described functionality. In this case, the base machine learning model can be a large model such as Copilot that has been trained using docstrings or other functional descriptions of code for a wide range of programming languages. The context-specific training data used to derive a given context-specific model from the base model can include only code descriptions and corresponding code examples for a particular programming language.

Another example could be a natural language text generation scenario. Consider a BLOOM or GPT-3-based model that answers questions for users. A user might want to employ a model to write poetry about certain subjects, and then later ask detailed scientific questions. One context-specific machine learning model could be derived from BLOOM or GPT-3 using a context-specific training dataset of poetry examples written by human users accompanied by user descriptions of the poems. Another context-specific machine learning model could be derived from BLOOM or GPT-3 by using actual scientific questions and answers from scientists as a context-specific training dataset.

In the case of image processing, different labeled training datasets can be obtained. For instance, human users could label images of wild mammals with the correct species to obtain a first context-specific training dataset, and could label images of flowers with the correct species to obtain a second context-specific training dataset. A single large model such as ResNet-50 or NASNet Large could serve as a base machine learning model from which a mammal-recognition and flower-recognition context-specific models could be derived.

As another example, a text-to-image model such as Stable Diffusion could serve as a base machine learning model. Respective context-specific models could be derived from such a base machine learning model using pairs of textual inputs and corresponding images for different contexts. For instance, a first context-specific training dataset could include images of artwork (e.g., paintings) and corresponding descriptions of the paintings. A second context-specific training dataset could include images of landscapes (e.g., mountains, lakes, meadows, forests) and corresponding descriptions of the landscapes. Similar approaches can be employed for models that generate other types of media, such as audio and/or video.

### Technical Effect

As noted above, modern inference hardware can greatly accelerate the efficiency with which inference operations can be performed on a given client device. However, many models are far too large to be used directly on a client device. By starting with a large base machine learning model and deriving smaller context-specific models therefrom, it is feasible to implement inference processing on client-side hardware.

As noted, modern inference hardware architectures have limitations such as constrained memory sizes, or may only provide specific hardware instructions that implement operations that tend to be done in neural networks, such as convolution or matrix operations. For instance, inference hardware architectures can provide instructions that perform convolution operations with specific input/output tensor and/or kernel sizes, vector or matrix operations with specific input or output tensor sizes, pooling operations, activation functions, etc. When a machine learning model is developed with convolution or matrix operations that are supported by a given inference hardware architecture, the machine learning model can be run very efficiently on processing units that support that architecture.

By searching for models that meet the memory constraints of inference hardware and/or that include inference operations that are supported by inference hardware architecture, new models can be identified that exhibit comparable accuracy to a base model in a specific context. Likewise, by pruning parameters from a large base machine learning model, context-specific machine learning models that meet hardware constraints can be obtained.

In addition, by compressing context-specific machine learning models into respective slices, it is plausible to deliver the models over a network on an as-needed basis as the context on a given client device changes. Thus, a given client device can swap context-specific machine learning models in and out of memory as needed, while consuming reasonable bandwidth to obtain the models over a network. Further, because the decompressed layers are sufficiently small to fit in the SRAM of an NPU, the decompressed layers can execute efficiently on the client device.

### Definitions

For the purposes of this document, the term “inference hardware architecture” refers to a set of operations provided by one or more inference processing units adapted for machine learning inference processing. For instance, the inference operations can be implemented in dedicated circuitry on the processing units that are configured to use specific data sizes (e.g., input sizes, output sizes, kernel sizes, etc.). The term “inference operation” refers to an operation performed by a machine learning model to perform a task. For instance, an inference operation can be performed by applying learned parameters obtained by training the machine learning model.

The term “base machine learning model” refers to a model that has been trained for a range of contexts. The term “context-specific machine learning model” refers to a model derived from a base machine learning model and adapted to a particular context. The term “context” refers to any type of use case for a machine learning model, e.g., a particular application scenario.

The term “learned parameters” refers to parameters such as edge weights and bias values that are learned by training a machine learning model, such as a neural network. The term “operation” refers to a function that can be performed by one or more nodes. The term “model structure” refers to an overall architecture of a model, including the number of layers or nodes, the connectivity of the layers, and/or the type of operations performed by individual layers. The term “neural network structure” refers to the model structure of a neural network. The term “trained model” refers to a model structure together with learned parameters for the model structure. Note that two trained models can share the same model structure and yet have different learned parameters, e.g., if the two models are trained on different training data or if there are underlying stochastic processes in the training process.

The term “parent model” refers to a model that is subsequently modified to obtain a “child model.” A “seed model” is one type of parent model, e.g., a preexisting model that is selected as a starting point for a search of a machine learning model search space. The term “final model” is only used herein to imply that a given model is designated for practical use in an application. In some cases, a final model output by a first search of a machine learning model search space can be subsequently employed as a seed model to initiate a second search, resulting in a second final model.

### Device Implementations

As noted above with respect to FIG. 9, system 900 includes several devices, including a client device 910, a server 920, a client device 930, and a client device 940. As also noted, not all device implementations can be illustrated and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 950. Without limitation, network(s) 950 can include one or more local area networks (LANs), wide area networks (WANs), the Internet, and the like.

Various examples are described above. Additional examples are described below. One example includes a method comprising obtaining a plurality of context-specific machine learning models, each context-specific machine learning model being derived from a base machine learning model adapted to a plurality of contexts and each context-specific machine learning model being adapted to a different context of the plurality of contexts, detecting a particular context of a particular device, selecting a particular context-specific machine learning model from the plurality of context-specific machine learning models based at least on the particular context of the particular device, and providing the particular context-specific machine learning model to the particular device.

Another example can include any of the above and/or below examples where the method further comprises detecting that the particular device has switched to another context and responsive to detecting that the particular device has switched to the another context, selecting another context-specific machine learning model from the plurality of context-specific machine learning models based at least on the another context and providing the another context-specific machine learning model to the particular device.

Another example can include any of the above and/or below examples where the method further comprises determining the particular context and the another context using an automated context prediction algorithm based at least on context data received from the particular device.

Another example can include any of the above and/or below examples where the base machine learning model is adapted to generate code in a plurality of programming languages, the particular context relates to a particular programming language, and the particular context-specific machine learning model is adapted to generate code in the particular programming language.

Another example can include any of the above and/or below examples where the base machine learning model is adapted to recognize a plurality of object types in images and the particular context-specific machine learning model is adapted to recognize a subset of the plurality of object types.

Another example can include any of the above and/or below examples where the method further comprises compressing the particular context-specific machine learning model to obtain a compressed version and sending the compressed version to the particular device over a network.

Another example can include any of the above and/or below examples where the compressed version has respective slices corresponding to individual layers of the particular context-specific machine learning model.

Another example includes a method comprising obtaining a base machine learning model adapted for a plurality of contexts, deriving, from the base machine learning model, multiple context-specific machine learning models adapted for different contexts of the plurality of contexts, and outputting the multiple context-specific machine learning models for use in the different contexts.

Another example can include any of the above and/or below examples where the deriving comprises employing the base machine learning model as a teacher and the multiple context-specific machine learning models as students.

Another example can include any of the above and/or below examples where the deriving comprises adjusting parameters of a particular context-specific machine learning model to adapt the particular context-specific machine learning model to a particular context, the adjusting being performed using a loss function that is based on respective output distributions of the base machine learning model and the particular context-specific machine learning model when executed on particular context-specific training data for the particular context.

Another example can include any of the above and/or below examples where the deriving comprises performing a search to identify an architecture shared by each of the multiple context-specific machine learning models.

Another example can include any of the above and/or below examples where the search starts with a seed model architecture and iteratively selects new parent models from a pareto frontier according to two or more criteria.

Another example can include any of the above and/or below examples where the search is constrained based on a hardware constraint for an inference processing unit.

Another example can include any of the above and/or below examples where the pareto frontier includes a first criterion relating to the loss function.

Another example can include any of the above and/or below examples where the deriving comprises pruning parameters from the base machine learning model.

Another example can include any of the above and/or below examples where the pruning is based at least on a magnitude or gradient of the parameters of the base machine learning model when trained on particular context-specific training data for a particular context.

Another example includes a computing device comprising a hardware processing unit and a storage resource storing computer-readable instructions which, when executed by the hardware processing unit, cause the hardware processing unit to receive a particular context-specific machine learning model adapted for a particular context, the particular context-specific machine learning model having been derived from a base machine learning model adapted for a plurality of contexts and execute the particular context-specific machine learning model on the computing device when the computing device is in the particular context.

Another example can include any of the above and/or below examples where the computer-readable instructions, when executed by the hardware processing unit, cause the hardware processing unit to receive another context-specific machine learning model derived from the base machine learning model and adapted for another context and execute the another context-specific machine learning model on the computing device when the computing device is in the another context.

Another example can include any of the above and/or below examples where hardware processing unit comprises a central processing unit, the computing device further comprising an inference processing unit and an inference processing unit memory, wherein the computer-readable instructions, when executed by the central processing unit, cause the central processing unit to retrieve compressed slices of the particular context-specific machine learning model, decompress the slices, and load the decompressed slices into the inference processing unit memory for execution by the inference processing unit.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
obtaining a plurality of context-specific machine learning models, each context-specific machine learning model being derived from a base machine learning model adapted to a plurality of contexts and each context-specific machine learning model being adapted to a different context of the plurality of contexts;
detecting a particular context of a particular device;
selecting a particular context-specific machine learning model from the plurality of context-specific machine learning models based at least on the particular context of the particular device; and
providing the particular context-specific machine learning model to the particular device.

2. The method of claim 1, further comprising:
detecting that the particular device has switched to another context; and
responsive to detecting that the particular device has switched to the another context:
selecting another context-specific machine learning model from the plurality of context-specific machine learning models based at least on the another context; and
providing the another context-specific machine learning model to the particular device.

3. The method of claim 2, further comprising:
determining the particular context and the another context using an automated context prediction algorithm based at least on context data received from the particular device.

4. The method of claim 1, wherein the base machine learning model is adapted to generate code in a plurality of programming languages, the particular context relates to a particular programming language, and the particular context-specific machine learning model is adapted to generate code in the particular programming language.

5. The method of claim 1, wherein the base machine learning model is adapted to recognize a plurality of object types in images and the particular context-specific machine learning model is adapted to recognize a subset of the plurality of object types.

6. The method of claim 1, further comprising:
compressing the particular context-specific machine learning model to obtain a compressed version and sending the compressed version to the particular device over a network.

7. The method of claim 6, the compressed version having respective slices corresponding to individual layers of the particular context-specific machine learning model.

8. A method comprising:
obtaining a base machine learning model adapted for a plurality of contexts;
deriving, from the base machine learning model, multiple context-specific machine learning models adapted for different contexts of the plurality of contexts; and
outputting the multiple context-specific machine learning models for use in the different contexts.

9. The method of claim 8, the deriving comprising:
employing the base machine learning model as a teacher and the multiple context-specific machine learning models as students.

10. The method of claim 9, the deriving comprising:
adjusting parameters of a particular context-specific machine learning model to adapt the particular context-specific machine learning model to a particular context,
the adjusting being performed using a loss function that is based on respective output distributions of the base machine learning model and the particular context-specific machine learning model when executed on particular context-specific training data for the particular context.

11. The method of claim 10, the deriving comprising:
performing a search to identify an architecture shared by each of the multiple context-specific machine learning models.

12. The method of claim 11, the search starting with a seed model architecture and iteratively selecting new parent models from a pareto frontier according to two or more criteria.

13. The method of claim 12, the search being constrained based on a hardware constraint for an inference processing unit.

14. The method of claim 12, the pareto frontier including a first criterion relating to the loss function.

15. The method of claim 8, the deriving comprising:
pruning parameters from the base machine learning model.

16. The method of claim 15, the pruning being based at least on a magnitude or gradient of the parameters of the base machine learning model when trained on particular context-specific training data for a particular context.

17. A computing device comprising:
a hardware processing unit; and
a storage resource storing computer-readable instructions which, when executed by the hardware processing unit, cause the hardware processing unit to:
receive a particular context-specific machine learning model adapted for a particular context, the particular context-specific machine learning model having been derived from a base machine learning model adapted for a plurality of contexts; and
execute the particular context-specific machine learning model on the computing device when the computing device is in the particular context.

18. The computing device of claim 17, wherein the computer-readable instructions, when executed by the hardware processing unit, cause the hardware processing unit to:
receive another context-specific machine learning model derived from the base machine learning model and adapted for another context; and
execute the another context-specific machine learning model on the computing device when the computing device is in the another context.

19. The computing device of claim 18, the hardware processing unit comprising a central processing unit, the computing device further comprising an inference processing unit and an inference processing unit memory, wherein the computer-readable instructions, when executed by the central processing unit, cause the central processing unit to:
retrieve compressed slices of the particular context-specific machine learning model;
decompress the slices; and
load the decompressed slices into the inference processing unit memory for execution by the inference processing unit.

20. The computing device of claim 19, wherein the compressed slices include parameters of individual layers of the particular context-specific machine learning model.
